(19) United States
(12) Patent Application Publication
(10) Pub. No.: US 2017/0327294 A1
(43) Pub. Date: Nov. 16, 2017

(54) HUMIDITY CONTROLLING CONTAINER

(71) Applicants: Atsuhiko YAMAZAKI, Matsudo-shi (JP); Taro ENJOJI, Matsudo-shi (JP)

(72) Inventors: Atsuhiko YAMAZAKI, Matsudo-shi (JP); Taro ENJOJI, Matsudo-shi (JP)

(73) Assignee: YOSHINO KOGYOSHO CO., LTD., Tokyo (JP)

(21) Appl. No.: 15/526,912

(22) PCT Filed: Jan. 25, 2016
(86) PCT No.: PCT/JP2016/051984

§ 371 Date: May 15, 2017

(30) Foreign Application Priority Data
Mar. 31, 2015 (JP) 2015-073619

(51) Int. Cl. B65D 81/26; B32B 27/08; B32B 27/32; B65D 65/40

(52) U.S. Cl. CPC B65D 81/264; B65D 65/40; B32B 27/08; B32B 27/32

(57) ABSTRACT

A humidity controlling container including an accommodating chamber wherein a wall portion thereof includes an innermost layer which defines the accommodating chamber, a first resin composition layer which surrounds innermost layer from the accommodating chamber's opposite side, a second resin composition layer which surrounds first resin composition layer from the accommodating chamber's opposite side, and an outermost layer which surrounds second resin composition layer from the accommodating chamber's opposite side, wherein first resin composition layer has a higher dehumidification capacity than the second resin composition layer, the second resin composition layer has a larger water absorbable amount than first resin composition layer, the innermost and outermost layers are formed of an olefin-based resin, the first and second resin composition layer are formed of an olefin-based resin mixed with a moisture absorbent, and an intermediate layer formed of an olefin-based resin is interposed between the first and second resin composition layers.

### TECHNICAL FIELD

The present invention relates to a humidity controlling container.

Priority is claimed on Japanese Patent Application No. 2015-073619, filed Mar. 31, 2015, the content of which is incorporated herein by reference.

### BACKGROUND ART

Contents sealed inside an accommodating chamber of a container main body may deteriorate in quality due to moisture between the time the container main body is sealed and the time a consumer opens the container. Therefore, conventionally, a configuration with a wall portion of the container main body in which a resin composition layer mixed with a moisture absorbent is provided is known as illustrated in Patent Document 1 below, for example.

### DOCUMENT OF RELATED ART

### Patent Document

### [Patent Document 1]

Japanese Unexamined Patent Application, First Publication No. 2005-220149

### SUMMARY OF INVENTION

### Technical Problem

However, in the conventional humidity controlling container, it may be difficult to maintain humidity of an accommodating chamber at a low level because a resin composition layer absorbs not only humidity of the accommodating chamber but also humidity of outside air.

In consideration of the above-mentioned circumstances, the present invention is directed to providing a humidity controlling container in which humidity of the accommodating chamber can reliably be maintained at a low level.

### Solution to Problem

A humidity controlling container of the present invention includes an accommodating chamber in which contents are accommodated, wherein a wall portion thereof includes an innermost layer which defines the accommodating chamber, a first resin composition layer which surrounds the innermost layer from a side opposite to the accommodating chamber, a second resin composition layer which surrounds the first resin composition layer from the side opposite to the accommodating chamber, and an outermost layer which surrounds the second resin composition layer from the side opposite to the accommodating chamber, the first resin composition layer has a higher dehumidification capacity for a space of the same volume than the second resin composition layer, the second resin composition layer has a larger absorbable amount of water than the first resin composition layer, the innermost layer and the outermost layer are formed of an olefin-based resin, the first resin composition layer and the second resin composition layer are formed of an olefin-based resin mixed with a moisture absorbent, and an intermediate layer formed of an olefin-based resin is interposed between the first resin composition layer and the second resin composition layer.

According to the present invention, since the second resin composition layer surrounds the first resin composition layer from the side opposite to the accommodating chamber and moisture from outside air is absorbed by the second resin composition layer even when moisture from outside air penetrates the outermost layer, moisture from outside air reaching the first resin composition layer can be suppressed. Moreover, since the second resin composition layer has a larger absorbable amount of water than the first resin composition layer, it is possible for the second resin composition layer to absorb a large amount of moisture, for example, even when the period from sealing to unsealing becomes long or the humidity controlling container is placed in an environment with high humidity, and thereby moisture from outside air reaching the first resin composition layer can be reliably suppressed.

Therefore, since moisture from outside air is not easily absorbed by the first resin composition layer having a higher dehumidification capacity than the second resin composition layer, this allows the first resin composition layer to absorb moisture intensively in the accommodating chamber and thereby humidity of the accommodating chamber can be reliably maintained at a low level.

Also, transfer of moisture absorbed by one side of the first resin composition layer and the second resin composition layer to the other side can be prevented by the intermediate layer between the first resin composition layer and the second resin composition layer, and thereby it is possible for moisture from outside air to be reliably absorbed by the second resin composition layer and for moisture of the accommodating chamber to be absorbed by the first resin composition layer.

Also, since the innermost layer, the first resin composition layer, the intermediate layer, the second resin composition layer, and the outermost layer are formed of an olefin-based resin, a solid bond between these layers can be easily and reliably achieved.

Here, a thickness of the intermediate layer may be smaller than each thickness of the first resin composition layer and the second resin composition layer.

In this case, since the thickness of the intermediate layer is smaller than each thickness of the first resin composition layer and the second resin composition layer, increases in weight, cost and size of the humidity controlling container can be suppressed.

Also, the first resin composition layer may have a higher dehumidification capacity per unit weight than the second resin composition layer and the second resin composition layer may have a larger absorbable amount of water per unit weight than the first resin composition layer.

In this case, since the first resin composition layer has a higher dehumidification capacity per unit weight than the second resin composition layer and the second resin composition layer has a larger absorbable amount of water per unit weight than the first resin composition layer, increases in weight, cost and size of the humidity controlling container can be reliably suppressed.

### Effects of Invention

According to the present invention, humidity of an accommodating chamber can be reliably maintained at a low level.

### BRIEF DESCRIPTION OF DRAWINGS

FIG. 1 is a partial longitudinal sectional view of a humidity controlling container illustrated as one embodiment according to the present invention.

### DESCRIPTION OF EMBODIMENTS

Hereinafter, one embodiment of the present invention will be described with reference to the drawings.

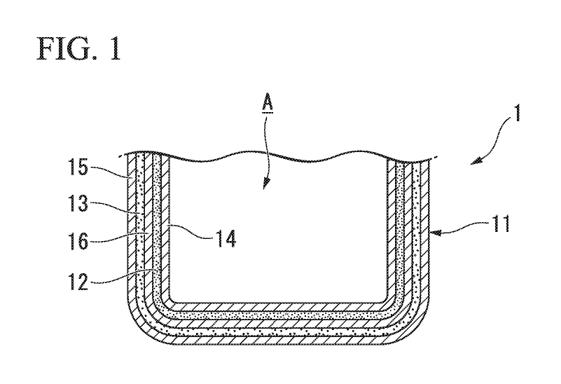

As illustrated in FIG. 1, a humidity controlling container 1 according to the present embodiment includes an accommodating chamber A in which contents are accommodated and a wall portion 11 includes an innermost layer 14 which defines the accommodating chamber A, a first resin composition layer 12 which surrounds the innermost layer 14 from a side opposite to the accommodating chamber A, a second resin composition layer 13 which surrounds the first resin composition layer 12 from the side opposite to the accommodating chamber A, and an outermost layer 15 which surrounds the second resin composition layer 13 from the side opposite to the accommodating chamber A.

Here, the wall portion 11 of the humidity controlling container 1 is formed in a cylindrical shape with a bottom, and the first resin composition layer 12, the second resin composition layer 13, the outermost layer 15, and the innermost layer 14 are also formed in a cylindrical shape with a bottom.

The outermost layer 15 and the innermost layer 14 are formed of an olefin-based resin such as polyethylene, polypropylene, or a cyclic olefin, which do not contain a moisture absorbent, for example.

The first resin composition layer 12 and the second resin composition layer 13 are formed of an olefin-based resin such as polyethylene or polypropylene, in which a moisture absorbent is mixed, for example.

Examples of the moisture absorbent include one of calcium oxide, magnesium sulfate, a molecular sieve, silica gel, calcium chloride and silica alumina gel, or a mixture of a plurality thereof. In addition, the molecular sieve is a crystalline zeolite and is represented by Expression (1) below.

M_{2/n}O.Al₂O₃.xSiO₂.yH₂O (1)

In Expression (1), “M” represents a metal cation (sodium or the like, for example) and “n” represents an atomic value.

The first resin composition layer 12 has a higher dehumidification capacity for a space of the same volume than the second resin composition layer 13. In addition, the dehumidification capacity refers to an ability to lower and maintain humidity of a space of the same volume at the lowered level. Also, the second resin composition layer 13 has a larger absorbable amount of water than the first resin composition layer 12. The absorbable amount of water is an amount of water that can be absorbed.

Further, in the present embodiment, the first resin composition layer 12 has a higher dehumidification capacity per unit weight than the second resin composition layer 13, and the second resin composition layer 13 has a larger absorbable amount of water per unit weight than the first resin composition layer 12.

A moisture absorbent contained in the first resin composition layer 12 has a higher dehumidification capacity per unit weight than a moisture absorbent contained in the second resin composition layer 13, and the moisture absorbent contained in the second resin composition layer 13 has a larger absorbable amount of water per unit weight than the moisture absorbent contained in the first resin composition layer 12.

Calcium oxide and the like are examples of the moisture absorbent contained in the first resin composition layer 12, and magnesium sulfate and the like are examples of the moisture absorbent contained in the second resin composition layer 13. The moisture absorbents are mixed in the first resin composition layer 12 and the second resin composition layer 13 in an amount of 50 wt % or more.

In the present embodiment, an intermediate layer 16 formed of an olefin-based resin which does not contain a moisture absorbent is interposed between the first resin composition layer 12 and the second resin composition layer 13. The intermediate layer 16 is formed in a cylindrical shape with a bottom as in the first resin composition layer 12, the second resin composition layer 13, the outermost layer 15, and the innermost layer 14.

A thickness of the intermediate layer 16 is smaller than the thicknesses of either of the first resin composition layer 12 or the second resin composition layer 13. In addition, the thickness of the intermediate layer 16 is in a range of about 30 μm to 100 μm, for example. In the humidity controlling container 1, the thickness of the innermost layer 14 is the smallest and the thickness of the first resin composition layer 12 is the largest.

For example, the outermost layer 15 and the intermediate layer 16 are formed of high density polyethylene, the innermost layer 14 is formed of low density polyethylene, the first resin composition layer 12 is formed of polyethylene mixed with 60 wt % calcium oxide, and the second resin composition layer 13 is formed of polyethylene mixed with 60 wt % magnesium sulfate.

In the configuration, for example, thicknesses of the outermost layer 15 and the intermediate layer 16 are equal to each other, the thickness of the innermost layer 14 is half the thickness of each of the outermost layer 15 and the intermediate layer 16, the thickness of the first resin composition layer 12 is about 5.5 times the thickness of each of the outermost layer 15 and the intermediate layer 16, and the thickness of the second resin composition layer 13 is about twice the thickness of each of the outermost layer 15 and the intermediate layer 16.

As described above, according to the humidity controlling container 1 of the present embodiment, since the second resin composition layer 13 surrounds the first resin composition layer 12 from the side opposite to the accommodating chamber A and moisture from outside air is absorbed by the second resin composition layer 13 even when moisture from outside air penetrates through the outermost layer 15, moisture from outside air reaching the first resin composition layer 12 can be suppressed. Moreover, since the second resin composition layer 13 has a larger absorbable amount of water than the first resin composition layer 12, it is possible for the second resin composition layer 13 to absorb a large amount of moisture even when the period from sealing to unsealing becomes long or the humidity controlling container 1 is placed in an environment with high humidity. Accordingly, moisture from outside air reaching the first resin composition layer 12 can be reliably suppressed.

Therefore, since moisture from outside air is not easily absorbed by the first resin composition layer 12 having higher dehumidification capacity than the second resin composition layer 13, this allows the first resin composition layer 12 to absorb moisture intensively in the accommodating chamber A and thereby the humidity of the accommodating chamber A can be reliably maintained at a low level.

Also, transfer of moisture absorbed by one side of the first resin composition layer 12 and the second resin composition layer 13 to the other side can be prevented by the intermediate layer 16 between the first resin composition layer 12 and the second resin composition layer 13. Therefore, it is possible for moisture from outside air to be reliably absorbed by the second resin composition layer 13 and for moisture of the accommodating chamber A to be absorbed by the first resin composition layer 12.

Also, since the innermost layer 14, the first resin composition layer 12, the intermediate layer 16, the second resin composition layer 13, and the outermost layer 15 are formed of olefin-based resins, a solid bond between these layers can be easily and reliably achieved.

Also, since the thickness of the intermediate layer 16 is smaller than each thickness of the first resin composition layer 12 and the second resin composition layer 13, increases in weight, cost and size of the humidity controlling container 1 can be suppressed.

Also, since the first resin composition layer 12 has a higher dehumidification capacity per unit weight than the second resin composition layer 13 and the second resin composition layer 13 has a larger absorbable amount of water per unit weight than the first resin composition layer 12, increases in weight, cost and size of the humidity controlling container 1 can be reliably suppressed.

In addition, the technical scope of the present invention is not limited to the above embodiment, and various changes can be made without departing from the spirit and scope of the present invention.

For example, the thickness of the intermediate layer 16 is made smaller than each thickness of the first resin composition layer 12 and the second resin composition layer 13 in the present embodiment but may be made equal to or larger than each thickness of the first resin composition layer 12 and the second resin composition layer 13.

Also, the dehumidification capacity per unit weight of the first resin composition layer 12 may be equal to or smaller than that of the second resin composition layer 13, or the absorbable amount of water per unit weight of the second resin composition layer 13 may be equal to or smaller than that of the first resin composition layer 12.

In addition, the components in the above-described embodiment can be appropriately replaced with well-known components without departing from the spirit and scope of the present invention, and furthermore, the above-described modifications may be appropriately combined.

### INDUSTRIAL APPLICABILITY

According to the present invention, humidity of an accommodating chamber can be reliably maintained at a low level.

### REFERENCE SIGNS LIST

1 Humidity controlling container
11 Wall portion
12 First resin composition layer
13 Second resin composition layer
14 Innermost layer
15 Outermost layer
16 Intermediate layer
A Accommodating chamber

1. A humidity controlling container comprising an accommodating chamber in which contents are accommodated,
wherein a wall portion thereof includes:
an innermost layer which defines the accommodating chamber;
a first resin composition layer which surrounds the innermost layer from a side opposite to the accommodating chamber;
a second resin composition layer which surrounds the first resin composition layer from the side opposite to the accommodating chamber; and
an outermost layer which surrounds the second resin composition layer from the side opposite to the accommodating chamber,
the first resin composition layer has a higher dehumidification capacity for a space of the same volume than the second resin composition layer, and the second resin composition layer has a larger absorbable amount of water than the first resin composition layer;
the innermost layer and the outermost layer are formed of an olefin-based resin;
the first resin composition layer and the second resin composition layer are formed of an olefin-based resin mixed with a moisture absorbent; and
an intermediate layer formed of an olefin-based resin is interposed between the first resin composition layer and the second resin composition layer.

2. The humidity controlling container according to claim 1, wherein a thickness of the intermediate layer is smaller than each thickness of the first resin composition layer and the second resin composition layer.

3. The humidity controlling container according to claim 1, wherein the first resin composition layer has a higher dehumidification capacity per unit weight than the second resin composition layer; and
the second resin composition layer has a larger absorbable amount of water per unit weight than the first resin composition layer.

4. The humidity controlling container according to claim 2, wherein the first resin composition layer has a higher dehumidification capacity per unit weight than the second resin composition layer; and
the second resin composition layer has a larger absorbable amount of water per unit weight than the first resin composition layer.
